(19) United States
(12) Patent Application Publication
(10) Pub. No.: US 2004/0179297 A1
(43) Pub. Date: Sep. 16, 2004

(54) Perpendicular magnetic recording head

(75) Inventor: Hiroshi Kameda, Niigata-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/797,397

(22) Filed: Mar. 10, 2004

(30) Foreign Application Priority Data
Mar. 14, 2003 (JP) 2003-069329

(51) Int. Cl. G11B 5/147

(52) U.S. Cl. 360/126

(57) ABSTRACT

An auxiliary magnetic layer of a perpendicular magnetic recording head has inclined faces that connect a front end face and side faces so that the width in the track width direction of the auxiliary magnetic layer gradually increases in the height direction from the front end face. Since the angular portions are thereby made obtuse, a magnetic flux returning from a recording medium can be diffused over a wide area without being overconcentrated. For this reason, even when a magnetomotive force is increased by increasing a recording current applied to a coil layer, the auxiliary magnetic layer can be restrained from performing unnecessary recording and erasing on and from the recording medium, and the intensity of a magnetic flux supplied from a main magnetic layer to the recording medium can be increased. As a result, the recording performance can be appropriately enhanced.

### BACKGROUND OF THE INVENTION

1. Field of the Invention

The present invention relates to a perpendicular magnetic recording head that performs recording on a recording medium, such as a disk having a hard film, by applying a perpendicular magnetic field to the recording medium, and more particularly, to a perpendicular magnetic recording head that enhances the recording performance by improving the shapes of an auxiliary magnetic layer and a light shield layer.

2. Description of the Related Art

Perpendicular magnetic recording apparatuses are known as apparatuses for recording magnetic data on a recording medium, such as a disk, at high density. FIG. 6 is a partial perspective view showing the general configuration of a perpendicular magnetic recording head for use in such a perpendicular magnetic recording apparatus.

A perpendicular magnetic recording head H shown in FIG. 6 is provided at a side face of a slider (not shown) that flies above or slides on a recording medium.

An auxiliary magnetic layer 1 is composed of a ferromagnetic material, and a main magnetic layer 2 similarly composed of a ferromagnetic material is provided above the auxiliary magnetic layer 1 with a predetermined space therebetween. The auxiliary magnetic layer 1 and the main magnetic layer 2 oppose each other in the layer thickness direction (Z-direction in the figure) at a face opposing the recording medium.

The perpendicular magnetic recording head H is of a single pole type, and includes a yoke layer 3 that is combined with the rear part of the main magnetic layer 2 in the height direction (Y-direction) and that has a width T1 larger than the width Tw in the track width direction (X-direction) of the main magnetic layer 2.

As shown in FIG. 6, the auxiliary magnetic layer 1 and the yoke layer 3 are magnetically connected by a connecting portion 4 interposed between the base ends of the layers.

A coil layer 5 (only one turn is shown in FIG. 6) is spirally wound around the connecting portion 4.

By supplying a current to the coil layer 5, a recording magnetic field is induced in the auxiliary magnetic layer 1 and in the main magnetic layer 2 through the yoke layer 3. Then, a leakage recording magnetic field between a front end face 1a of the auxiliary magnetic layer 1 and a front end face 2a of the main magnetic layer 2 is oriented in the direction perpendicular to the recording medium.

Since the area of the front end face 2a of the main magnetic layer 2 is sufficiently smaller than the area of the front end face 1a of the auxiliary magnetic layer 1, a magnetic flux φ from the main magnetic layer 2 is concentrated onto a surface of the recording medium opposing the front end face 2a of the main magnetic layer 2, thereby recording magnetic data.

A perpendicular magnetic recording head is disclosed in, for example, Japanese Unexamined Patent Application Publication No. 2000-182205. An auxiliary magnetic layer of the disclosed perpendicular magnetic recording head (“a lower magnetic pole” in that publication) seems to have the same shape as that shown in FIG. 6.

Since the auxiliary magnetic layer 1 is rectangular in plan view, as shown in FIG. 6, corner portions 1c are provided on the borders between the front end face 1a opposing the recording medium and side faces 1b extending in the height direction on both sides in the track width direction. The angle θ1 formed between the front end face 1a and the side faces 1b is a right angle.

For this reason, the shape of the auxiliary magnetic layer 1 shown in FIG. 6 causes the following problems: That is, when a perpendicular magnetic flux is applied from the main magnetic layer 2 to the recording medium and returns to the auxiliary magnetic layer 1, it is prone to concentrate at the corner portions 1c of the auxiliary magnetic layer 1. When a magnetomotive force is increased by increasing a recording current supplied to the coil layer 5, the corner portions 1c perform recording on the recording medium.

Furthermore, magnetic data written on the recording medium is erased by a magnetic flux from the corner portions 1c.

Recording and erasing by the corner portions 1c can be restrained by weakening the magnetomotive force. In this case, however, a sufficient magnetic flux for recording cannot be obtained, and precise data recording on the recording medium is impossible. This reduces the recording performance.

When a light shield layer (not shown) is provided on the main magnetic layer 2 in some perpendicular magnetic recording heads, the above problems also may be caused because the light shield layer has right-angled corners at both ends of a front end face thereof.

### SUMMARY OF THE INVENTION

The present invention overcomes the above problems of the related art, and an object of the present invention is to provide a perpendicular magnetic recording head that can suppress unnecessary recording and erasing by an auxiliary magnetic layer and a light shield layer by improving the shapes of the layers in order to achieve high recording performance.

In order to achieve the above object, according to one aspect, the present invention provides a perpendicular magnetic recording head including a main magnetic layer, an auxiliary magnetic layer separated from the main magnetic layer at a medium-opposing face of the perpendicular magnetic recording head opposing a recording medium, and a coil layer disposed behind the medium-opposing face in the height direction to supply a recording magnetic field to the main magnetic layer and the auxiliary magnetic layer, wherein the perpendicular magnetic recording head records magnetic data on the recording medium with a perpendicular magnetic field that concentrates on the main magnetic layer, and wherein inclined faces or curved faces are provided on both sides in the track width direction of the auxiliary magnetic layer so that the width in the track width direction of the auxiliary magnetic layer gradually increases in the height direction from a front end face close to the medium-opposing face.

By thus providing inclined faces or curved faces on both sides in the track width direction of the auxiliary magnetic layer so that the width in the track width direction of the auxiliary magnetic layer gradually increases in the height direction from a front end face close to the medium-opposing face, right-angled corner portions are not provided at both ends of the front end face, and obtuse angular portions are provided, or no angular portions are provided at both ends of the front end face. Therefore, when a magnetic flux returns from the recording medium to the auxiliary magnetic layer, it is diffused over a wide area on the front end face and the inclined or curved faces of the auxiliary magnetic layer, and is thereby easily absorbed.

As a result, since unnecessary recording and erasing by the auxiliary magnetic layer can be suppressed, even when the magnetomotive force is increased by increasing the recording current, a sufficient magnetic flux for recording can be produced by the main magnetic layer, and the recording performance can be enhanced.

According to another aspect, the present invention provides a perpendicular magnetic recording head including a main magnetic layer, an auxiliary magnetic layer separated from the main magnetic layer at a medium-opposing face of the perpendicular magnetic recording head opposing a recording medium, a coil layer disposed behind the medium-opposing face in the height direction to supply a recording magnetic field to the main magnetic layer and the auxiliary magnetic layer, and a light shield layer disposed on the main magnetic layer with an insulating layer therebetween, wherein the perpendicular magnetic recording head records magnetic data on the recording medium with a perpendicular magnetic field that concentrates on the main magnetic layer, and wherein at least one of the auxiliary magnetic layer and the light shield layer has inclined faces or curved faces on both sides in the track width direction so that the width thereof in the track width direction gradually increases in the height direction from a front end face close to the medium-opposing face.

Since the light shield layer does not form a magnetic circuit with the main magnetic layer, which is different from the auxiliary magnetic layer, the degree to which the light shield layer causes unnecessary recording and erasing is lower than that of the auxiliary magnetic layer. However, when the light shield layer has right-angled portions at both ends of the front end face, the portions absorb the magnetic flux in a concentrated manner, and the intensity of a magnetic field emitted from the portions toward the recording medium is increased. Therefore, it is preferable that the light shield layer also have inclined or curved faces so that the width thereof in the track width direction increases in the height direction from the front end face.

Preferably, the inclined faces connect the front end face to side faces extending rearward in the height direction on both sides in the track width direction.

Alternatively, it is preferable that the curved faces connect the front end face to side faces extending rearward in the height direction on both sides in the track width direction, and be convex toward the medium-opposing face from imaginary planes that connect side ends in the track width direction of the front end face to leading ends of the side faces close to the medium-opposing face.

The front end face may be exposed from the medium-opposing face, or may be recessed in parallel from the medium-opposing face in the height direction.

According to a further aspect, the present invention provides a perpendicular magnetic recording head including a main magnetic layer, an auxiliary magnetic layer separated from the main magnetic layer at a medium-opposing face of the perpendicular magnetic recording head opposing a recording medium, and a coil layer disposed behind the medium-opposing face in the height direction to supply a recording magnetic field to the main magnetic layer and the auxiliary magnetic layer, wherein the perpendicular magnetic recording head records magnetic data on the recording medium with a perpendicular magnetic field that concentrates on the main magnetic layer, and wherein the auxiliary magnetic layer includes a front end face curved at the medium-opposing face so that the width in the track width direction of the auxiliary magnetic layer increases in the height direction from the medium-opposing face, and side faces extending rearward in the height direction from base ends of the front end face on both sides in the track width direction.

According to a still further aspect, the present invention provides a perpendicular magnetic recording head including a main magnetic layer, an auxiliary magnetic layer separated from the main magnetic layer at a medium-opposing face of the perpendicular magnetic recording head opposing a recording medium, a coil layer disposed behind the medium-opposing face in the height direction to supply a recording magnetic field to the main magnetic layer and the auxiliary magnetic layer, and a light shield layer disposed on the main magnetic layer with an insulating layer therebetween, wherein the perpendicular magnetic recording head records magnetic data on the recording medium with a perpendicular magnetic field that concentrates on the main magnetic layer, and wherein at least one of the auxiliary magnetic layer and the light shield layer includes a front end face curved at the medium-opposing face so that the width in the track width direction of the auxiliary magnetic layer and/or the light shield layer increases in the height direction from the medium-opposing face, and side faces extending rearward in the height direction from base ends of the front end face on both sides in the track width direction.

In the above cases, since the entire front end face of the auxiliary magnetic layer and/or the light shield layer is curved, angular portions are not provided at both ends of the front end face, and overconcentration of the magnetic flux returning to the auxiliary magnetic layer can be appropriately suppressed. Moreover, unnecessary recording and easing by the auxiliary magnetic layer can be suppressed even when the magnetomotive force is increased.

Further objects, features and advantages of the present invention will become apparent from the following description of the preferred embodiments with reference to the attached drawings.

### BRIEF DESCRIPTION OF THE DRAWINGS

FIG. 1 is a longitudinal sectional view of a magnetic head provided with a perpendicular magnetic recording head according to an embodiment of the present invention;

FIG. 2 is a partial perspective view of the perpendicular magnetic recording head shown in FIG. 1;

FIG. 3 is a plan view of an auxiliary magnetic layer shown in FIGS. 1 and 2;

FIG. 4 is a plan view of an auxiliary magnetic layer having another shape;

FIG. 5 is a plan view of an auxiliary magnetic layer having a further shape; and

FIG. 6 is a partial perspective view of a known perpendicular magnetic recording head.

### DESCRIPTION OF THE PREFERRED EMBODIMENTS

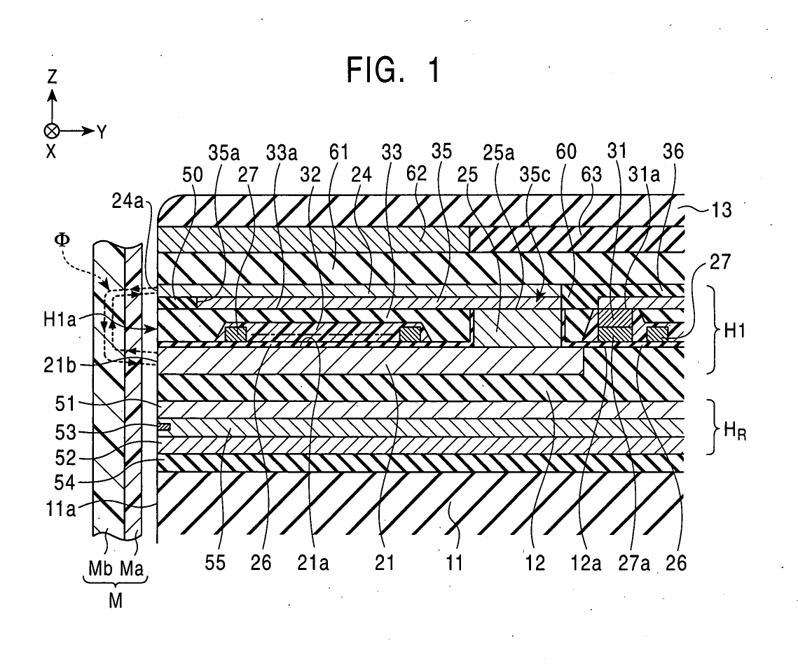

FIG. 1 is a longitudinal sectional view showing the configuration of a magnetic head provided with a perpendicular magnetic recording head according to an embodiment of the present invention.

A perpendicular magnetic recording head H1 shown in FIG. 1 magnetizes a hard film Ma of a recording medium M in a perpendicular direction by applying a perpendicular magnetic field to the recording medium M.

The recording medium M is shaped like a disk, and is rotatable around its center. The recording medium M includes a hard film Ma with high residual magnetization on its outer side, and a soft film Mb having a high magnetic permeability on its inner side.

A slider 11 is composed of a ceramic material such as Al₂O₃.TiC, and a face 11a of the slider 11 opposes the recording medium M. When the recording medium M rotates, the slider 11 floats above the surface of the recording medium M or slides on the recording medium M because of surface airflow. In FIG. 1, the recording medium M moves relative to the slider 11 in the Z-direction. The perpendicular magnetic recording head H1 is provided at a trailing end face of the slider 11.

A nonmagnetic insulating layer 54 made of an inorganic material, such as Al₂O₃ or SiO₂, is provided on an upper surface 11b of the slider 11, and a reading section H_{R} is provided on the nonmagnetic insulating layer 54.

The reading section H_{R} includes a lower shield layer 52, a gap layer 55, a magnetoresistive element 53, and an upper shield layer 51 stacked in that order from the lower side. The magnetoresistive element 53 is, for example, an anisotropic magnetoresistive (AMR) element, a giant magnetoresistive (GMR) element, or a tunneling magnetoresistive (TMR) element.

A nonmagnetic insulating layer 12 composed of an inorganic material, such as Al₂O₃ or SiO₂, is provided on the upper shield layer 51, and the perpendicular magnetic recording head H1 of the present invention is provided on the nonmagnetic insulating layer 12. The perpendicular magnetic recording head H1 is covered with a protective layer 13 composed of an inorganic nonmagnetic insulating material or the like. A medium-opposing face H1a of the perpendicular magnetic recording head H1 opposing the recording medium is substantially flush with the medium-opposing face 11a of the slider 11.

The perpendicular magnetic recording head H1 includes an auxiliary magnetic layer 21 plated with a ferromagnetic material such as permalloy (Ni—Fe). The upper shield layer 51 may also function as the auxiliary magnetic layer 21. The nonmagnetic insulating layer 12 is provided under and around the auxiliary magnetic layer 21. As shown in FIG. 1, an upper surface 21a of the auxiliary magnetic layer 21 and an upper surface 12a of the nonmagnetic insulating layer 12 are substantially flush with each other.

A connecting layer 25 composed of Ni—Fe or the like is provided on the upper surface 21a of the auxiliary magnetic layer 21 behind the medium-opposing face H1a in the height direction (Y-direction).

Around the connecting layer 25, an insulating underlayer 26 of Al₂O₃ or the like is provided on the upper surface 12a of the auxiliary magnetic layer 21 and the upper surface 12a of the nonmagnetic insulating layer 12. A coil layer 27 composed of a conductive material, such as Cu, is provided on the insulating underlayer 26. The coil layer 27 is formed by, for example, frame plating and is spirally patterned around the connecting layer 25 with a predetermined number of turns. A connecting layer 31 similarly composed of a conductive material, such as Cu, is provided on a connecting end 27a at the coil center of the coil layer 27.

The coil layer 27 and the connecting layer 31 are covered with an insulating layer 32 composed of an organic material such as a resist material, and is further covered with an insulating layer 33.

Preferably, the insulating layer 33 is composed of an inorganic insulating material. The inorganic insulating material is at least one of AlO, Al₂O₃, SiO₂, Ta₂O₅, TiO, AlN, AlSiN, TiN, SiN, Si₃N₄, NiO, WO, WO₃, BN, CrN, and SiON.

An upper surface 25a of the connecting layer 25, an upper surface 31a of the connecting layer 31, and an upper surface 33a of the insulating layer 33 are flattened to be flush with one another. Such flattening is performed by, for example, CMP (chemical mechanical polishing), as will be described in the following production method.

In the embodiment, a yoke layer 35 is provided on the insulating layer 33. As shown in FIG. 1, a front end face 35a of the yoke layer 35 is disposed behind the medium-opposing face H1a in the height direction (Y-direction). A base end portion 35c of the yoke layer 35 is provided on the upper surface 25a of the connecting layer 25 so that it is magnetically connected to the connecting layer 25. Since the insulating layer 33 disposed under the yoke layer 35 is flat, the yoke layer 35 can be patterned precisely.

A lead layer 36 is provided on the upper surface 31a of the connecting layer 31. The lead layer 36 can supply a recording current to the connecting layer 31 and the coil layer 27.

An insulating layer 50 is disposed on the insulating layer 33 on a side of the yoke layer 35 close to the medium-opposing face H1a, so that the front end face 35a of the yoke layer 35 is not exposed from the medium-opposing face H1a.

The upper surface of the insulating layer 50 and the upper surface of the yoke layer 35 form the same flat surface. A main magnetic layer 24 composed of a magnetic material, such as NiFe, is provided over the insulating layer 50 and the yoke layer 35. A front end face 24a of the main magnetic layer 24 is exposed from the medium-opposing face H1a.

A section behind the rear end faces in the height direction of the main magnetic layer 24 and the yoke layer 35 is filled with an insulating layer 60.

In the embodiment shown in FIG. 1, an insulating layer 61 is provided on the main magnetic layer 24 and the insulating layer 60, and a light shield layer 62 is provided on the insulating layer 61. A section behind the rear end face in the height direction of the light shield layer 62 is filled with an insulating layer 63, and the protective layer 13 is provided on the light shield layer 62 and the insulating layer 63.

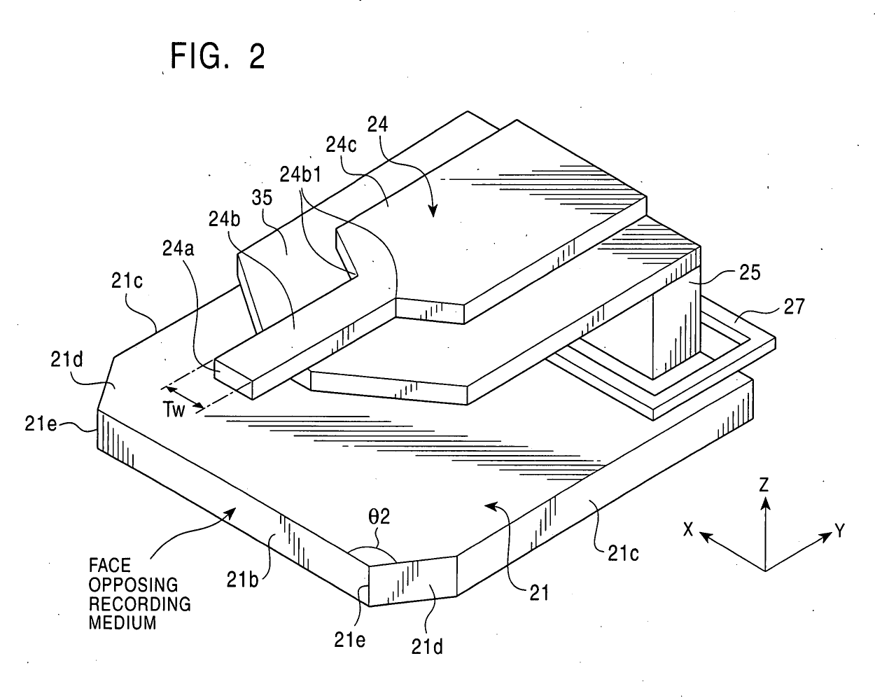

FIG. 2 is a partial perspective view showing the structures of the auxiliary magnetic layer 21, the yoke layer 35, the main magnetic layer 24, the connecting layer 25, and the coil layer 27 (only one turn is shown) shown in FIG. 1.

Referring to FIG. 2, the auxiliary magnetic layer 21 includes a front end face 21b exposed from the medium-opposing face H1a, side faces 21c extending rearward in the height direction (Y-direction) on both sides in the track width direction (X-direction), and inclined faces 21d connecting the front end face 21b and the side faces 21c so that the width in the track width direction of the auxiliary magnetic layer 21 gradually increases.

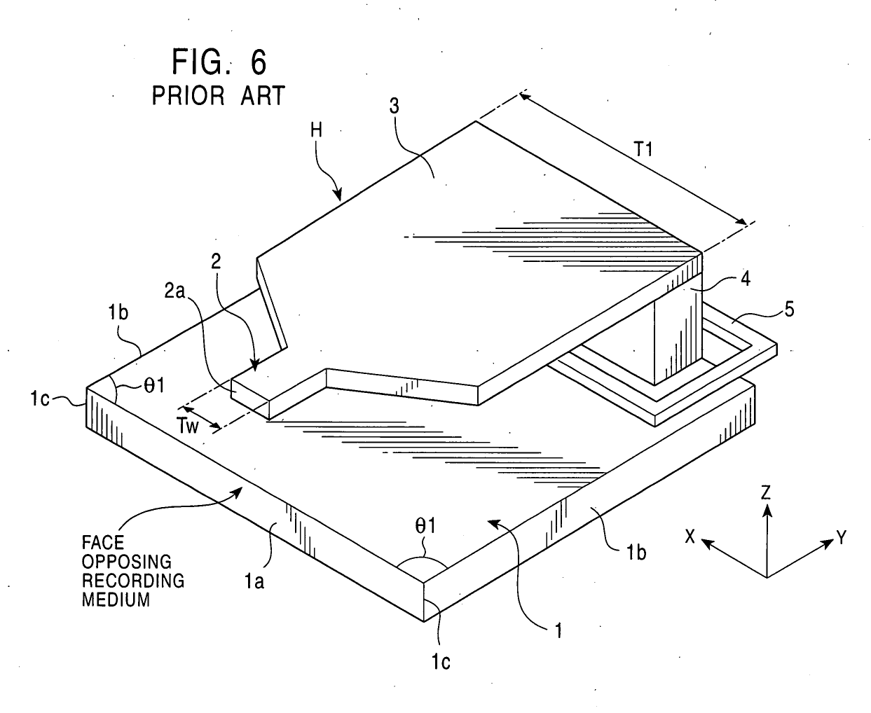

The width in the track width direction of the yoke layer 35 is larger than that of the main magnetic layer 24 disposed thereon. The main magnetic layer 24 includes a front portion 24b that extends in the height direction (Y-direction) from a front end face 24a exposed from the medium-opposing face H1a and that has a substantially fixed width Tw, and a rear portion 24c extending from both side base portions 24b1 of the front portion 24b so that its width in the track width direction gradually increases. The shape of the main magnetic layer 24 is not limited to that shown in FIG. 2. For example, the main magnetic layer 24 may have only the front portion 24b having the track width Tw. The rear portion 24c may have the track width Tw, in a manner similar to that in the front portion 24b. The main magnetic layer 24 may be provided under the yoke layer 35, or may be combined with the yoke layer 35, as shown in FIG. 6.

The embodiment shown in FIGS. 1 and 2 is characterized in the shape of the auxiliary magnetic layer 21.

In the related art shown in FIG. 6, the auxiliary magnetic layer 1 includes the front end face 1a exposed from the medium-opposing face opposing the recording medium, and the side faces 1b extending in the height direction from both ends in the track width direction of the front end face 1a. The right-angled corner portions 1c are provided between the front end face 1a and the side faces 1b.

In contrast, in the present invention shown in FIG. 2, the inclined faces 21d are formed between the front end face 21b and the side faces 21c, for example, by chamfering. Along the inclined faces 21d, the width in the track width direction of the auxiliary magnetic layer 21 gradually increases in the height direction from the front end face 21b.

The inclined faces 21d are inclined with respect to the height direction (Y-direction), and angular portions 21e are provided on the borders between the front end face 21b and the inclined faces 21d. However, the angle θ2 between the front end face 21b and the inclined faces 21d obtuse. Therefore, when a perpendicular magnetic flux φ is supplied from the main magnetic layer 24 to the recording medium M and returns from the recording medium M to the auxiliary magnetic layer 21, it does not concentrate on the angular portions 21e, but is dispersed to the front end face 21b and the inclined faces 21d. The dispersed magnetic flux φ is easily absorbed. For this reason, even when a magnetomotive force is increased by increasing a recording current applied to the coil layer 27, a magnetic flux generated at the angular portions 21e is weak. Consequently, the angular portions 21e can be prevented from performing recording and from erasing recorded data. As a result, the perpendicular magnetic flux φ generated from the main magnetic layer 24 can be increased by increasing the magnetomotive force, and the recording performance can be enhanced for higher-density recording.

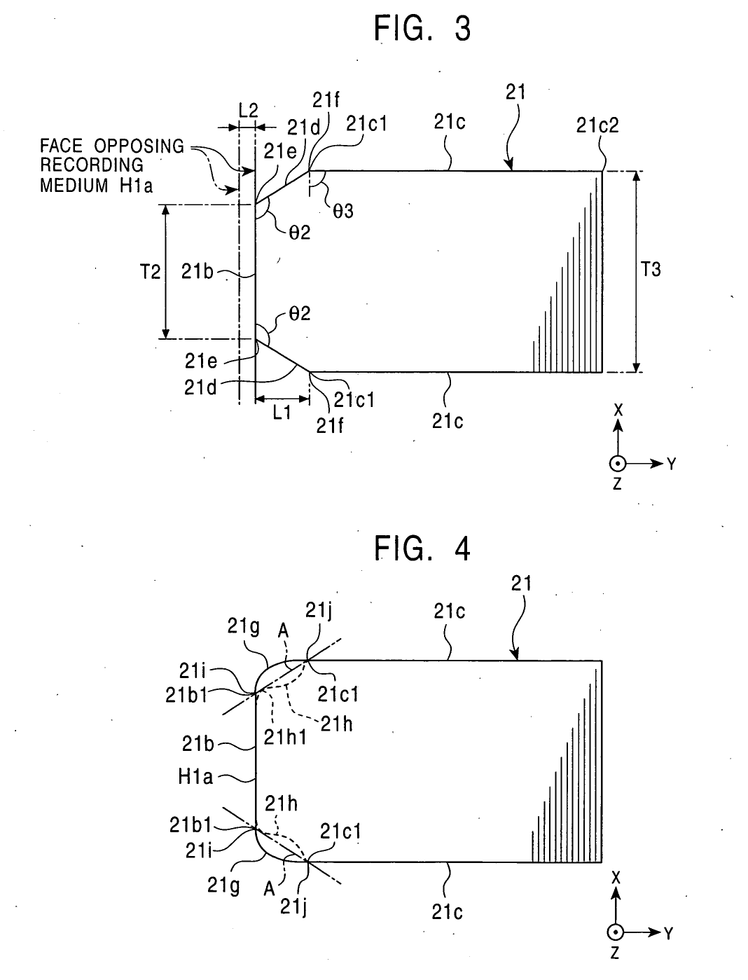

FIG. 3 is a plan view of the auxiliary magnetic layer 21 shown in FIGS. 1 and 2. The front end face 21b of the auxiliary magnetic layer 21 is exposed from the medium-opposing face H1a opposing the recording medium, and is parallel to the X-Z plane. While the side faces 21c extending in the height direction on both sides in the track width direction of the auxiliary magnetic layer 21 are, preferably, flat faces parallel to the Y-Z plane, they need not always be parallel thereto. For example, the side faces 21c may be inclined with respect to the height direction between leading ends 21c 1 close to the medium-opposing face H1a, and base ends 21c2 on the rear side, or may be curved.

For example, in a case in which the side faces 21c are inclined with respect to the height direction, the inclination angle of the side faces 21c is set to be different from the inclination angle of the inclined faces 21d. Therefore, the angle θ3 formed between the side faces 21c and an imaginary plane parallel to the front end face 21b is not a right angle, but is an obtuse angle. This makes it possible to restrain a magnetic flux, which returns from the recording medium to the auxiliary magnetic layer 21, from concentrating on angular portions 21f on the borders between the inclined faces 21d and the side faces 21c.

The angle θ2 between the front end face 21b and the inclined faces 21d of the auxiliary magnetic layer 21 is more than or equal to 90°, and less than 180°, more preferably, within the range of 135° to 175°. When the angle θ2 is less than 135°, even if a normal recording current (more specifically, within the range of 10 mA to 70 mA) is supplied to the coil layer 27, the angular portions 21e on the borders between the front end face 21b and the inclined faces 21d are prone to generate a magnetic field having such an intensity as to perform recording on the recording medium. When the angle θ2 exceeds 175°, the length L1 in the height direction between side ends 21b1 in the track width direction of the front end face 21b, and the leading ends 21c 1 of the side faces 21c is too short. Consequently, a magnetic field produced from the angular portions 21f on the borders between the inclined faces 21d and the side faces 21c is not efficiently attenuated until it reaches the recording medium, and the angular portions 21f may perform recording on the recording medium and erasing data on the recording medium. Accordingly, it is preferable that the angle θ2 be within the range of 135° to 175°.

It is preferable that the above-described length L1 be within the range of 1 μm to 10 μm. When the length L1 is less than 1 μm, the angular portions 21f on the borders between the inclined faces 21d and the side faces 21c are prone to perform recording and erasing on and from the recording medium, as described above.

In contrast, when the length l1 is more than 10 μm, the angle θ2, and the widths T2 and T3 cannot be set within the proper ranges.

As shown in FIG. 3, T2 represents the width in the track width direction (X-direction) of the front end face 21b of the auxiliary magnetic layer 21, and T3 represents the width between the side faces 21c disposed on both sides in the track width direction. The width T3 refers to the maximum width between the side faces 21c. It is preferable that the width T2 be within the range of 10 μm to 190 μm and that the width T3 be within the range of 20 μm to 200 μm. It is also preferable that the ratio of the width T2 to the width T3 {(T2/T3)×100} be within the range of 50% to 95%.

When the ratio is less than 50%, the area of the front end face 21b exposed from the medium-opposing face H1a is too small, and the front end face 21b cannot efficiently absorb a magnetic flux returning from the recording medium. When the ratio is more than 95%, the angle θ2 and the length L1 cannot be set within the above proper ranges.

While the front end face 21b of the auxiliary magnetic layer 21 is exposed from the medium-opposing face H1a in the above embodiment, it need not be always exposed. For example, the medium-opposing face H1a may be disposed on a one-dot chain line shown in FIG. 3, and the front end face 21b may be recessed by the length L2 from the medium-opposing face H1a. In such a case, it is preferable that the front end face 21b be parallel to the medium-opposing face H1a. When the front end face 21b is thus recessed by the length L2, the angular portions 21e between the front end face 21b and the inclined faces 21d and the angular portions 21f between the inclined faces 21d and the side faces 21c are positioned apart from the recording medium. Therefore, even if a magnetic flux is supplied from these angular portions toward the recording medium, it is efficiently attenuated until it reaches the recording medium. This can more effectively restrain the angular portions 21e and 21f from performing recording and erasing on and from the recording medium.

However, when the length L2 is too large, a magnetic flux returning from the recording medium cannot be effectively absorbed by the auxiliary magnetic layer 21. Therefore, it is preferable that the length L2 be more than 0 μm, and less than or equal to 5 μm.

FIG. 4 is a plan view of an auxiliary magnetic layer 21 as a modification of the above embodiment. The auxiliary magnetic layer 21 has a shape different from that of the auxiliary magnetic layer 21 of the embodiment shown in FIG. 3. In the this modification, curved faces 21g connect a front end face 21b and side faces 21c that constitute the auxiliary magnetic layer 21.

The curved faces 21g are convex toward a medium-opposing face H1a from imaginary planes A that connect side ends 21b1 in the track width direction (X-direction) of the front end face 21b to leading ends 21c 1 of the side faces 21c close to the medium-opposing face H1a.

By thus making the curved faces 21g convex, no angular portions are provided between the front end face 21b and the curved faces 21g and between the curved faces 21g and the side faces 21c, so that a magnetic flux returning from the recording medium M toward the auxiliary magnetic layer 21 can be easily diffused over a wide area on the front end face 21b and the curved faces 21g. For this reason, even when a magnetomotive force is increased by increasing a recording current applied to the coil layer 27, the auxiliary magnetic layer 21 can be restrained from performing unnecessary recording and erasing on and from the recording medium M. As a result, the magnetomotive force and the intensity of the magnetic field produced from the main magnetic layer 24 toward the recording medium M can be increased, and the recording performance is enhanced.

The convexly curved faces 21g may be replaced with concavely curved faces 21h that are recessed from the imaginary planes A in the height direction and that connect the front end face 21b and the side faces 21c. When the concavely curved faces 21h are provided, however, angular portions are slightly prone to be formed on the borders 21i between the front end face 21b and the curved faces 21h and on the borders 21j between the curved faces 21g and the side faces 21c. In order to further reduce such angular portions, it is preferable to adopt the convexly curved faces 21g.

In FIG. 4, the angle θ2 shown in FIG. 3 is defined by the angle formed between tangents extending from the midpoints of the curved faces 21g or 21h, and the front end face 21b. For example, in the case of the convexly curved faces 21g that have a constant curvature, the angle formed between the tangents extending from the midpoints of the curved faces 21g, and the front end face 21b corresponds to the angle θ2 in FIG. 3. In contrast, in the case of the concavely curved faces 21h having two different curvatures, the angle formed between tangents extending from the midpoints of curved faces 21h1 closer to the medium-opposing face H1a, and the front end face 21b corresponds to the angle θ2 in FIG. 3.

The relationship between the front end face 21b and the medium-opposing face H1a, the width T2 of the front end face 21b, the width T3 between the side faces 21c, and so on are the same as those in the above embodiment shown in FIG. 3.

While the auxiliary magnetic layer 21 includes the front end face 21b, the side faces 21c, and the inclined faces or curved faces that connect the front end face 21b and the side faces 21c shown in FIGS. 3 and 4, the present invention is not limited to the above structures. It is satisfactory if the auxiliary magnetic layer 21 includes the front end face 21b, and inclined or curved faces that allow the width in the track width direction of the auxiliary magnetic layer 21 to gradually increase in the height direction from both ends of the front end face 21b. Therefore, the auxiliary magnetic layer 21 may be, for example, trapezoidal in plan view.

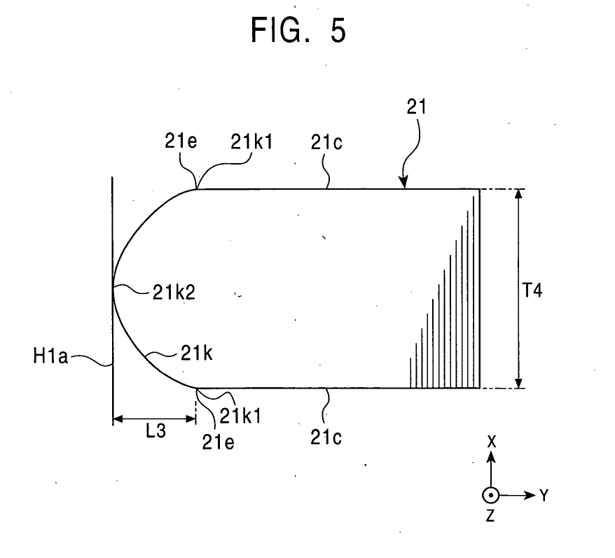

FIG. 5 is a plan view of an auxiliary magnetic layer 21 as another modification. The auxiliary magnetic layer 21 has a shape different from those in FIGS. 3 and 4, and does not include inclined or curved faces that connect a front end face and side faces. A front end face 21k disposed at a medium-opposing face H1a is curved so that the width in the track width direction (X-direction) of the auxiliary magnetic layer 21 gradually increases in the height direction (Y-direction) from the medium-opposing face H1a. Side faces 21c extend rearward in the height direction on both sides in the track width direction from base ends 21k1 of the front end face 21k.

While a portion of the front end face 21k just along a center line 21k2 in the Z-direction is exposed from the medium-opposing face H1a in FIG. 5, the entire front end face 21k may be recessed from the medium-opposing face H1a in the height direction. In such a case, the distance in the height direction between the medium-opposing face H1a and the center line 21k2 of the front end face 21k is more than 0 μm, and less than or equal to 5 μm.

In this modification, the front end face 21k is curved so that the length L3 in the height direction between the center line 21k2 of the front end face 21k and the base ends 21k1 is within the range of 1 μm to 10 μm, and so that the width T4 in the track width direction between the base ends 21k1 is within the range of 20 μm to 200 μm. By setting the values in the above ranges, the front end face 21k can be smoothly recessed from the center line 21k2 toward the base ends 21k1 on both sides. Moreover, the boundaries 21k1 between the front end face 21k and the side faces 21c can be appropriately shifted backward in the height direction. Therefore, a magnetic flux returning from the recording medium to the auxiliary magnetic layer 21 can be diffused to a wider area on the front end face 21k.

The above-described structures shown in FIGS. 3 to 5 are also applicable to the light shield layer 62 shown in FIG. 1.

Since the auxiliary magnetic layer 21 forms a magnetic circuit with the main magnetic layer 24, the yoke layer 35, and the connecting layer 25, in a case in which a magnetomotive force is increased by increasing a recording current applied to the coil layer 27, when the auxiliary layer 21 is rectangular as before, the problems of unnecessary recording and erasing become more serious. In contrast, since the light shield layer 62 does not form a magnetic circuit with the other magnetic layers, such problems are less serious than in the auxiliary magnetic layer 21.

However, when the light shield layer 62 is rectangular, a magnetic field from the recording medium easily concentrates at right-angle corners on both sides of the front end face of the light shield layer 62, and the intensity of the magnetic field increases at the corners. Consequently, there is a danger of leakage of a magnetic field, which allows recording, from the corners toward the recording medium.

Accordingly, it is also preferable that the light shield layer 62 have a planar shape shown in FIG. 3, 4, or 5.

The auxiliary magnetic layer 21 may be rectangular as before, and the light shield layer 62 may have a planar shape shown in FIG. 3, 4, or 5. Alternatively, the light shield layer 62 may be rectangular as before, and the auxiliary magnetic layer 21 may have a planar shape shown in FIG. 3, 4, or 5. In the case of a perpendicular magnetic head having a light shield layer, it is most preferable that both the auxiliary magnetic layer 21 and the light shield layer 62 have a planar shape shown in FIG. 3, 4, or 5. In such a case, the auxiliary magnetic layer 21 and the light shield layer 62 need not always have the same shape, and may have different shapes. For example, the auxiliary magnetic layer 21 may have a planar shape shown in FIG. 4, and the light shield layer 62 may have a planar shape shown in FIG. 3.

The auxiliary magnetic layer 21 shown in FIG. 3, 4, or 5 is formed, for example, by plating and sputtering. The auxiliary magnetic layer 21 can be formed by forming a resist pattern shown in FIG. 3, 4, or 5 during plating, or by chamfering the corners between the front end and the side faces of a auxiliary magnetic layer having a rectangular shape, as shown in FIG. 6, for example, by etching. This also applies to the light shield layer 62.

The auxiliary magnetic layer 21 shown in FIG. 3, 4, or 5 provides an obtuse angle θ2 between the front end face 21b and the inclined faces 21d, or removes angular portions between the front end face 21b and the curved faces 21g or 21h. Therefore, a magnetic flux returning from the recording medium can be diffused over a wide area, and can be restrained from concentrating at the corners on both sides in the track width direction of the front end face 21b. For this reason, even when the electromotive force is increased by increasing the recording current applied to the coil layer 27, unnecessary recording and erasing by the auxiliary magnetic layer 21 can be restrained. Consequently, the intensity of a magnetic field produced from the main magnetic layer 24 can be increased by increasing the magnetomotive force, and the recording performance can be more appropriately enhanced.

By also forming the light shield layer 62 in a planar shape shown in FIG. 3, 4, or 5, a magnetic field produced from the recording medium can be restrained from overconcentrating at a certain point on the light shield layer 62 and from being absorbed by the point, and unnecessary recording and erasing by the light shield layer 62 can be suppressed.

### EXAMPLES

The signal intensity for the recording medium at the angular portions 21e provided in the auxiliary magnetic layer 21 having a planar shape shown in FIG. 3 and the signal intensity for the recording medium at the corners 1c provided in the auxiliary magnetic layer 1 in the related art shown in FIG. 6 were measured and compared.

In the case of the rectangular auxiliary magnetic layer 1 shown in FIG. 6, when a recording current exceeded 25 mA, a magnetic field appeared at the corners 1c, and recording on the recording medium was performed by the corners 1c.

In contrast, in the case of the auxiliary magnetic layer 21 shown in FIG. 3 in which the angle θ2 between the front end face 21b and the inclined faces 21d was 135° and the length L1 between the front end face 21b and the leading ends 21c 1 of the side faces 21c was 5 μm, even when the recording current was increased to 60 mA, a magnetic field did not appear at the angular portions 21e on the borders between the front end face 21b and the inclined faces 21d. That is, it was shown that the angular portions 21e did not perform recording on the recording medium even when a high recording current was applied.

In the case of the auxiliary magnetic layer 21 shown in FIG. 3 in which the angle θ2 between the front end face 21b and the inclined faces 21d was 150° and the length L1 between the front end face 21b and the leading ends 21c 1 of the side faces 21c was 1 μm, even when the recording current was increased to 60 mA, a magnetic field did not appear at the angular portions 21e on the borders between the front end face 21b and the inclined faces 21d. That is, it was shown that the angular portions 21e did not perform recording on the recording medium even when a high recording current was applied.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A perpendicular magnetic recording head comprising:
a main magnetic layer;
an auxiliary magnetic layer separated from the main magnetic layer at a medium-opposing face of the perpendicular magnetic recording head opposing a recording medium; and
a coil layer disposed behind the medium-opposing face in the height direction to supply a recording magnetic field to the main magnetic layer and the auxiliary magnetic layer,
wherein the perpendicular magnetic recording head records magnetic data on the recording medium with a perpendicular magnetic field that concentrates on the main magnetic layer, and
wherein inclined faces or curved faces are provided on both sides in the track width direction of the auxiliary magnetic layer so that the width of the auxiliary magnetic layer in the track width direction gradually increases in the height direction from a front end face close to the medium-opposing face.

2. A perpendicular magnetic recording head comprising:
a main magnetic layer;
an auxiliary magnetic layer separated from the main magnetic layer at a medium-opposing face of the perpendicular magnetic recording head opposing a recording medium;
a coil layer disposed behind the medium-opposing face in the height direction to supply a recording magnetic field to the main magnetic layer and the auxiliary magnetic layer; and
a light shield layer disposed on the main magnetic layer with an insulating layer therebetween,
wherein the perpendicular magnetic recording head records magnetic data on the recording medium with a perpendicular magnetic field that concentrates on the main magnetic layer, and
wherein at least one of the auxiliary magnetic layer and the light shield layer has inclined faces or curved faces on both sides in the track width direction so that the width thereof in the track width direction gradually increases in the height direction from a front end face close to the medium-opposing face.

3. A perpendicular magnetic recording head according to claim 1, wherein the inclined faces connect the front end face to side faces extending rearward in the height direction on both sides in the track width direction of the auxiliary magnetic layer.

4. A perpendicular magnetic recording head according to claim 1, wherein the curved faces connect the front end face to side faces extending rearward in the height direction on both sides in the track width direction of the auxiliary magnetic layer, and are convex toward the medium-opposing face from imaginary planes that connect side ends in the track width direction of the front end face to leading ends of the side faces close to the medium-opposing face.

5. A perpendicular magnetic recording head according to claim 1, wherein the front end face is exposed from the medium-opposing face.

6. A perpendicular magnetic recording head according to claim 1, wherein the front end face is recessed in parallel from the medium-opposing face in the height direction.

7. A perpendicular magnetic recording head according to claim 2, wherein the inclined faces connect the front end face to side faces extending rearward in the height direction on both sides in the track width direction of said at least one of the auxiliary magnetic layer and the light shield layer.

8. A perpendicular magnetic recording head according to claim 2, wherein the curved faces connect the front end face to side faces extending rearward in the height direction on both sides in the track width direction of said at least one of the auxiliary magnetic layer, and are convex toward the medium-opposing face from imaginary planes that connect side ends in the track width direction of the front end face to leading ends of the side faces close to the medium-opposing face.

9. A perpendicular magnetic recording head according to claim 2, wherein the front end face is exposed from the medium-opposing face.

10. A perpendicular magnetic recording head according to claim 2, wherein the front end face is recessed in parallel from the medium-opposing face in the height direction.

11. A perpendicular magnetic recording head comprising:
a main magnetic layer;
an auxiliary magnetic layer separated from the main magnetic layer at a medium-opposing face of the perpendicular magnetic recording head opposing a recording medium; and
a coil layer disposed behind the medium-opposing face in the height direction to supply a recording magnetic field to the main magnetic layer and the auxiliary magnetic layer,
wherein the perpendicular magnetic recording head records magnetic data on the recording medium with a perpendicular magnetic field that concentrates on the main magnetic layer, and
wherein the auxiliary magnetic layer comprises:
a front end face curved at the medium-opposing face so that the width in the track width direction of the auxiliary magnetic layer increases in the height direction from the medium-opposing face; and
side faces extending rearward in the height direction from base ends of the front end face on both sides in the track width direction.

12. A perpendicular magnetic recording head comprising:
a main magnetic layer;
an auxiliary magnetic layer separated from the main magnetic layer at a medium-opposing face of the perpendicular magnetic recording head opposing a recording medium;
a coil layer disposed behind the medium-opposing face in the height direction to supply a recording magnetic field to the main magnetic layer and the auxiliary magnetic layer; and
a light shield layer disposed on the main magnetic layer with an insulating layer therebetween,
wherein the perpendicular magnetic recording head records magnetic data on the recording medium with a perpendicular magnetic field that concentrates on the main magnetic layer, and
wherein at least one of the auxiliary magnetic layer and the light shield layer comprises:
a front end face curved at the medium-opposing face so that the width in the track width direction of said at least one of the auxiliary magnetic layer and the light shield layer increases in the height direction from the medium-opposing face; and
side faces extending rearward in the height direction from base ends of the front end face on both sides in the track width direction.
